(19) United States
(12) Patent Application Publication
(10) Pub. No.: US 2024/0025642 A1
(43) Pub. Date: Jan. 25, 2024

(54) Transporting Device and Storage System

(71) Applicant: Ocado Innovation Limited, Hatfield, Hertfordshire (GB)

(72) Inventors: Ben THOMAS, Hatfield, Hertfordshire (GB); David SHARP, Hatfield, Hertfordshire (GB); Adam LANCASTER, Hatfield, Hertfordshire (GB); Sean CLARK, Hatfield, Hertfordshire (GB); Joseph ZAMMIT, Hatfield, Hertfordshire (GB); Yongji ZHOU, Hatfield, Hertfordshire (GB)

(73) Assignee: Ocado Innovation Limited, Hatfield, Hertfordshire (GB)

(21) Appl. No.: 18/042,884

(22) PCT Filed: Sep. 1, 2021
(86) PCT No.: PCT/EP2021/074088

§ 371 Date: Feb. 24, 2023

(30) Foreign Application Priority Data
Sep. 1, 2020 (GB) 2013719.6

(51) Int. Cl. B65G 1/10; B65G 1/04

(52) U.S. Cl. CPC B65G 1/10; B65G 1/0478; B65G 2201/0235

(57) ABSTRACT

The present invention provides a transporting device for a storage system which maximises storage capacity of the storage system whilst remaining scalable and avoiding overheads. The transporting device includes a frame having a Z-direction track and a tray for supporting the container. The tray includes an X-direction movement unit arranged to move the container in an X-direction, a Y-direction movement unit arranged to move the container in a Y-direction and a Z-direction movement unit arranged to move the tray in a Z-direction by way of interaction with the Z-direction track. The transporting device can include a frame having a Z-direction track and a first movement unit arranged to move the container in an X-direction and/or a Z-direction by with the Z-direction track. A second movement unit is arranged to move the container in a Y-direction and/or a Z-direction.

This application claims priority from UK Patent Application No. GB2013719.6 filed 1 Sep. 2020, the content of all this application hereby being incorporated by reference.

### TECHNICAL FIELD

The present invention relates generally to the field of robotic storage systems and more specifically to transporting devices which are arranged to form a cluster. The present invention further provides a method of relocating a transporting device.

### BACKGROUND

Some commercial and industrial activities require systems which enable the storage and retrieval of a large number of different products which may be stored in containers. Methods of handling containers stacked in rows have been well known for decades. In some such systems, for example as disclosed in U.S. Pat. No. 2,701,065 (Bertel), free-standing stacks of containers are arranged in rows in order to reduce the storage volume associated with storing such containers, but yet still providing access to a specific container if required. Access to a given container is made possible by providing relatively complicated hoisting mechanisms that can be used to stack and remove given containers from stacks. The costs of such systems are, however, impractical in many situations and they have mainly been commercialised for the storage and handling of large shipping containers.

The concept of using freestanding stacks of containers and providing a mechanism to retrieve and store specific containers has been developed further, for example as disclosed in European patent no. 0 767 113 (Cimcorp). This document discloses a mechanism for removing a plurality of stacked containers, using a robotic load handler in the form of a rectangular tube that is lowered around the stack of containers, and which is configured to be able to grip a container at any level in the stack. In this way, several containers can be lifted at once from a stack. The rectangular tube can be used to move several containers from the top of one stack to the top of another stack, or to move containers from a stack to an external location and vice versa. Such systems can be particularly useful where all of the containers in a single stack contain the same product. Such stacks are known as a single-product stacks. In the system disclosed in European patent no. 0 767 113, the height of the tube has to be at least as high as the height of the largest stack of containers, so that that the highest stack of containers can be extracted in a single operation. Accordingly, when used in an enclosed space such as a warehouse, the maximum height of the stacks is restricted by the need to accommodate the tube of the robotic load handler above the stack.

One known type of system for the storage and retrieval of items in multiple product lines involves arranging storage bins or containers in stacks on top of one another, the stacks being arranged in rows. The storage bins are removed from the stacks and accessed from above by robotic load handling devices, removing the need for aisles between the rows and allowing more containers to be stored in a given space.

European patent no. 1 037 828 (Autostore) discloses a system in which stacks of containers are arranged within a frame structure. Robotic load handling devices can be controllably moved around the stack on a system of tracks on the uppermost surface of the stack. Other forms of robotic load handling device are further disclosed in, for example, Norwegian patent no. 3 173 66.

UK patent publication no. 2 520 104 (Ocado Innovation Limited) discloses a robotic load handling device where each robotic load handler only covers one grid space, thus allowing higher density of robotic load handlers and thus higher throughput of a given size system. However, any suitable form of load handling device can be used.

However, each of the known robotic storage systems described above possess one or more of the following drawbacks. In all examples, a peripheral frame structure is required above/around the stacks of storage bins. The frame structure supports robotic load handlers traversing on top of the frame structure above the stacks of storage bins. The use of such a frame structure reduces the density at which storage bins may be stored because space is consumed by the frame structure. Moreover, such a frame structure isn't dynamically scalable because the frame structure must be constructed to accommodate the maximum anticipated capacity, even if such capacity is uncertain or in the far future.

Additionally, the robotic load handlers also have to “dig” down into a stack of storage bins in order to retrieve a selected storage bin, which represents a time and energy overhead when retrieving a storage bin. It also follows that the systems described above require robotic load handlers, which represent an additional cost of the system.

Furthermore, when coordinating such a system, positive progress by a robotic load hander from a start location to a destination location typically requires the robotic load handler to undertake a number of unnecessary, unproductive and/or costly steps, such as avoiding other robotic load handling devices using route planning and/or collision avoidance. Also, when a storage bin becomes stuck in a stack of storage bins, it is difficult to recover storage bins beneath the stuck storage bin. Similarly, when a robotic load handler breaks down, access to storage bins below the robotic load handler is restricted until the robotic load handler is removed from its location above the stack of storage bins. Additionally, it may be difficult to recover a robotic load handler when it breaks down.

### SUMMARY

In view of the problems in known storage systems, the present invention aims to provide a transporting device for a storage system which maximises the storage capacity of the storage system whilst remaining scalable and avoiding the above mentioned problems concerning robotic load handlers.

According to the present invention there is provided a transporting device for moving a container. The transporting device comprises a frame comprising a Z-direction track and a tray for supporting the container. The tray comprises an X-direction movement unit arranged to move the container in an X-direction, a Y-direction movement unit arranged to move the container in a Y-direction and a Z-direction movement unit arranged to move the tray in a Z-direction by way of interaction with the Z-direction track.

The present invention further provides a transporting device for moving a container. The transporting device comprises a frame comprising a Z-direction track and a first movement unit arranged to move the container in an X-direction and/or a Z-direction, wherein movement in the Z-direction is achieved by way of interaction with the Z-direction track. The transporting device further comprises a second movement unit arranged to move the container in a Y-direction and/or a Z-direction, wherein movement in the Z-direction is achieved by way of interaction with the Z-direction track.

The present invention further provides a storage system comprising a plurality of transporting devices, wherein each transporting device is as previously described. The plurality of transporting devices are arranged in a cluster so as to transfer containers in X, Y and Z-directions.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 is a schematic diagram of a transporting device according to a first embodiment of the present invention.

FIG. 2 is a schematic diagram of a transporting device according to a first embodiment further comprising a container for transportation.

FIG. 3 is a schematic diagram of a storage system according to a first embodiment of the present invention.

FIGS. 4a and 4b are schematic diagrams showing a first modification to the transporting device of the first embodiment.

FIGS. 5a and 5b are schematic diagrams showing a second modification to the transporting device of the first embodiment.

FIG. 6 is a schematic diagram of a storage system according to a second embodiment of the present invention.

FIG. 7 is a schematic diagram of a transporting device according to a second embodiment of the present invention further comprising a container.

FIG. 8 is a schematic diagram of a transporting device according to a second embodiment of the present invention with a first set of arms extended.

FIG. 9 is a schematic diagram of a transporting device according to a second embodiment of the present invention with a second set of arms extended.

FIG. 10 is a schematic diagram of a storage system according to a second embodiment of the present invention.

### DETAILED DESCRIPTION OF EMBODIMENTS

### First Embodiment

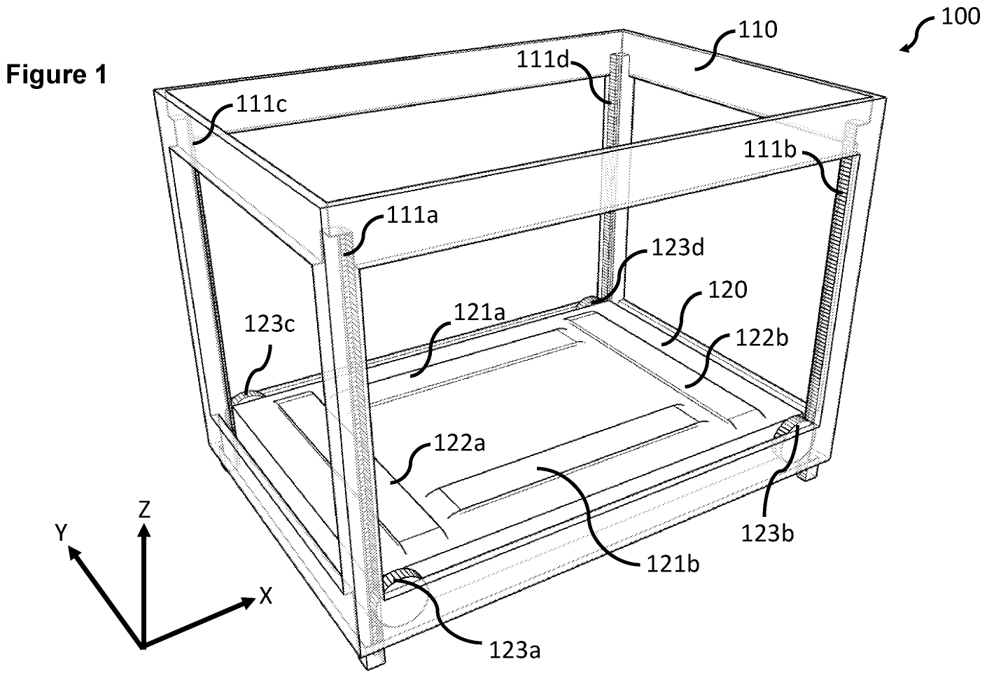

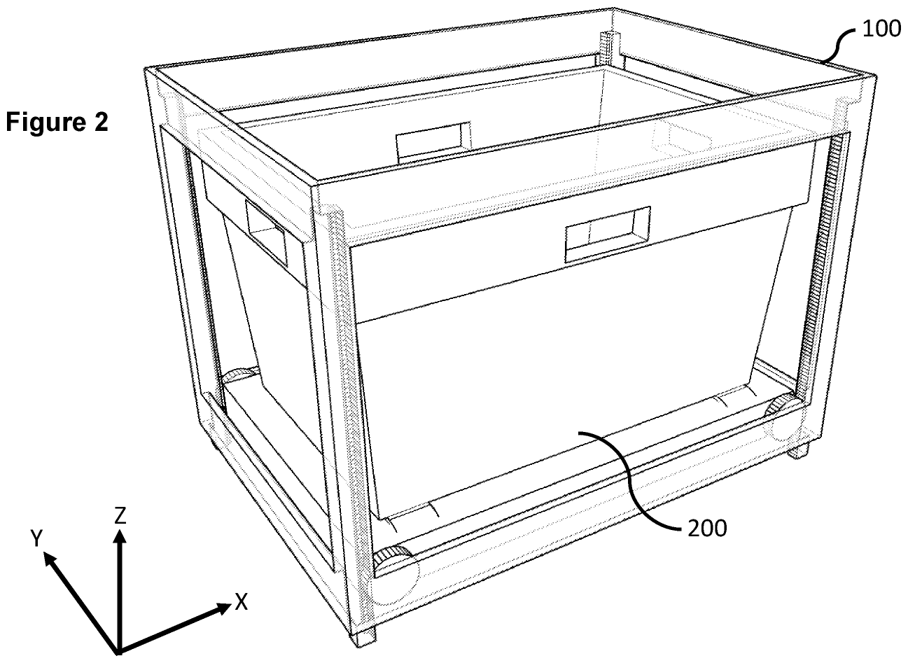

FIG. 1 shows a transporting device 100 according to a first embodiment of the present invention. FIG. 2 shows the transporting device 100 together with a container 200, the container 200 is one to be moved by the transporting device 100.

To achieve the movement, the transporting device 100 comprises a frame 110 and a tray 120. The tray 120 is for supporting the container 200 and permits the movement of the container in any of X, Y or Z directions. In this context, X, Y and Z directions are envisaged to comprise three dimensional directions which are arranged at right angles to one another.

To achieve transfer of the container 200 in each of X, Y and Z directions the frame 110 may comprise apertures through which the container 200 may pass into adjacent transporting devices or other facilities e.g. conveyor belts, pick stations, trucks or other storage or conveyance facilities. Apertures may be provided in the top and bottom of the frame 110 to allow the tray 120, with or without the container 200, to pass into the transporting device above or below.

To achieve this, the tray 120 comprises mechanisms to permit movement of the container 200 in X, Y or Z directions. The tray 120 may be arranged to be captive within the frame 110. The tray 120 may be wired to the frame for power and communications and hence the extent of its travel may be restricted, in other words, the tray 120 may be able to travel a small distance into the frame 110 above and below (if present), but essentially remains within the frame 110.

The tray 120 comprises an X-direction movement unit for moving the container in the X-direction. In the example shown in FIG. 1, the X-direction movement unit comprises a first conveyor belt 121a and a second conveyor belt 121b which are arranged to move the container in the X-direction.

Similarly, to achieve Y-direction movement of the container 200, the tray 120 comprises a Y-direction movement unit. In this example, the Y-direction movement unit comprises a first conveyor belt 122a and a second conveyor belt 122b which are arranged to move the container in the Y-direction.

To achieve Z-direction movement of the container 200, the tray 120 as a whole is arranged to move in the Z-direction by way of a Z-direction movement unit. In this way, the vertical position of the tray 120 can be changed with respect to the frame 110. In more detail, Z-direction movement of the container 200 is effected by way of interaction between at least one Z-direction track positioned on the frame and at least one pinion arranged on the tray 120. By rotating the pinion on the tray 120, the vertical position of the tray 120 with respect to the frame 110 is adjusted by climbing up or down the Z-direction track on the frame.

Although the Z-direction movement unit and corresponding Z-direction track have been described as a rack and pinion mechanisms, it is envisaged that other mechanisms may be used, for example, a linear motor mechanism or the like.

In the non-limiting example given in FIG. 1, four Z-direction tracks are positioned at each corner of the frame 110, in particular, the four Z-direction tracks comprise a first Z-direction track 111a, a second Z-direction track 111b, a third Z-direction track 111c and a fourth Z-direction track 111d. In this example, the Z direction tracks are provided as gear racks arranged to interact with a pinion mounted on the tray 120. The Z-direction movement unit in this example comprises four pinions arranged at each corner of the tray and each arranged to interact with a respective Z-direction track. For example, a first pinion 123a is arranged to interact with the first Z-direction track 111a, a second pinion 123b is arranged to interact with the second Z-direction track 111b, a third pinion 123c is arranged to interact with the third Z-direction track 111c and a fourth pinion 123d is arranged to interact with the fourth Z-direction track 111d.

In this way, the transporting device 100 of the first embodiment is arranged to permit the transfer of containers 120 between adjacent transporting devices 100 in all 3 dimensions.

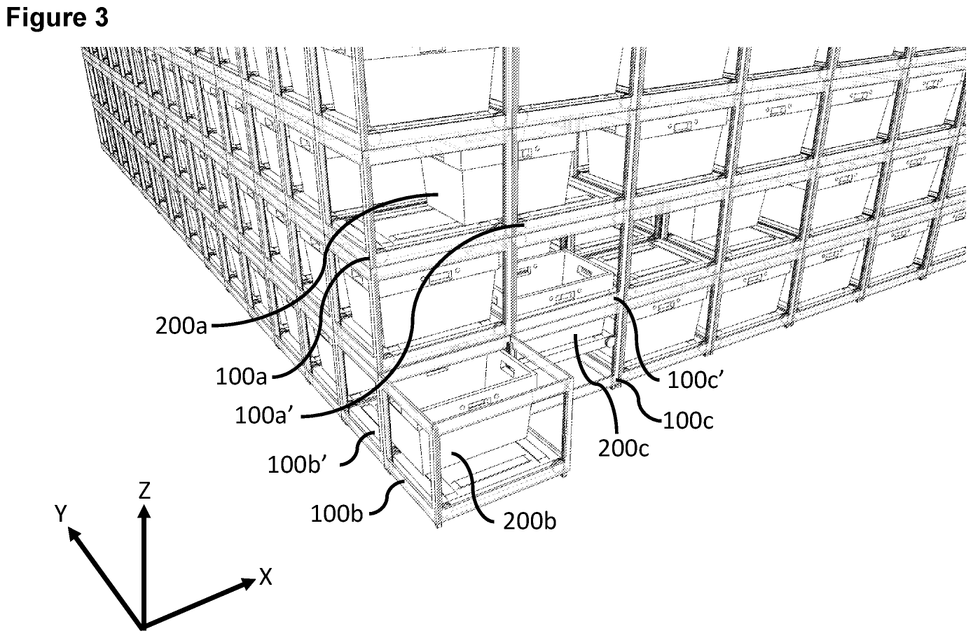

FIG. 3 shows the use of a plurality of transporting devices 100a, 100b, 100c arranged in a cluster to permit the transfer of containers 120 between adjacent transporting devices 100 in all 3 dimensions.

In particular, the transporting devices of the cluster are assembled side by side and/or on top of each other in any combination of X, Y and Z-directions to form any regular or irregular-shaped cluster.

In cluster, lateral movement in the X or Y directions is achieved by driving the appropriate conveyor belts in the two transporting devices concerned. For example, transporting device 100a is transferring container 200a in an X-direction to adjacent transporting device 100a′ by way of the X-direction movement unit. This process may be further assisted by the activation of X-direction movement unit in the transporting device 100a′.

Similarly, transporting device 100b is transferring container 200b in a Y-direction to adjacent transporting device 100b′ by way of the Y-direction movement unit. This process may be further assisted by the activation of Y-direction movement unit in the transporting device 100b′.

To achieve Z-direction movement requires the cooperation of a transporting device and its adjacent transporting device. For example, Z-direction movement is effected for container 200c by way of cooperation of transporting device 100c and transporting device 100c′.

In particular, to achieve vertical movement, the upper transporting device 100c′ must move its tray 120 upward out of the way, allowing the lower transporting device 100c to move its tray 120, carrying the container, upwards into the “home” position in the upper transporting device 100c′. From there, the container can be moved in X or Y-directions, and then both trays 120 can return to their home positions. A similar process is used to move a container down from transporting device 100c′ to transporting device 100c.

In this regard, the “home” position may be considered that position of the tray 120 as shown in FIGS. 1 and 2. In this position when a plurality of transporting devices 100 are arranged in a cluster then transporting devices 100 can transfer containers 200 in X or Y-directions because trays 120 in the cluster on the same level in the cluster has trays 120 arranged at the same vertical level.

It has been explained that the tray from the transporting device 100c may move into the transporting device 100c′ when moving in a Z-direction to thereby reach the home position of transporting device 100c′. From there the container 200c can be transferred in an X or Y-direction. To achieve this, the tray 120 of the transporting device 100c′ may move to the top of the frame 110 to permit space from the tray 120 of the transporting device 100c and the container it supports to fit in the frame 110 of transporting device 100c′. However, it is envisaged that the tray 120c may move significantly further than has been previously described. For example, the tray 120 of the upper transporting device 100c′ may move down into the lower transporting device 100c. However, further movements are envisaged in which the tray 120 of either of the transporting devices 100c and 100c′ may move further than a single neighbouring transporting device. For example, the tray may move multiples of transporting devices in the Z-direction by way of use of the Z-direction movement unit. It will be appreciated that the communications and power systems of the tray 120 will need to support this, using for example, batteries and RF control to effect these movements. In this way, a tray 120 may ascend or descend an entire stack of transporting devices 100 when other trays 120 permit such movements.

Although movement in the Z-direction is more difficult than movement in the X and Y-directions due to the requirement for cooperation between transporting devices this is not seen a disadvantage because in many applications the number of required movements in X and Y-directions is an order of magnitude larger than the number required in the Z-direction. Therefore, the Z-direction movement mechanism is not a limitation but rather is considered an optimisation or exploitation of the real world requirements.

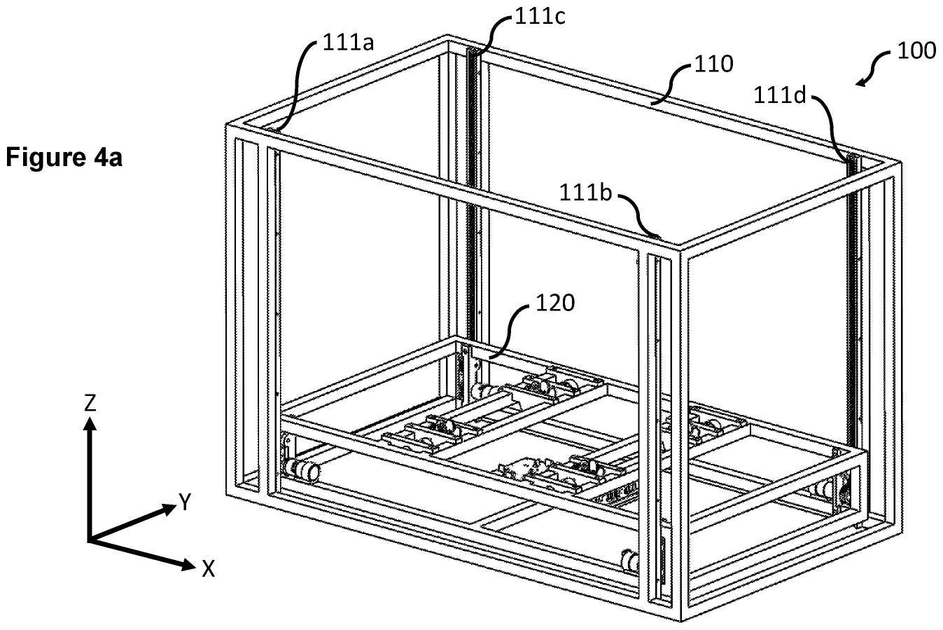

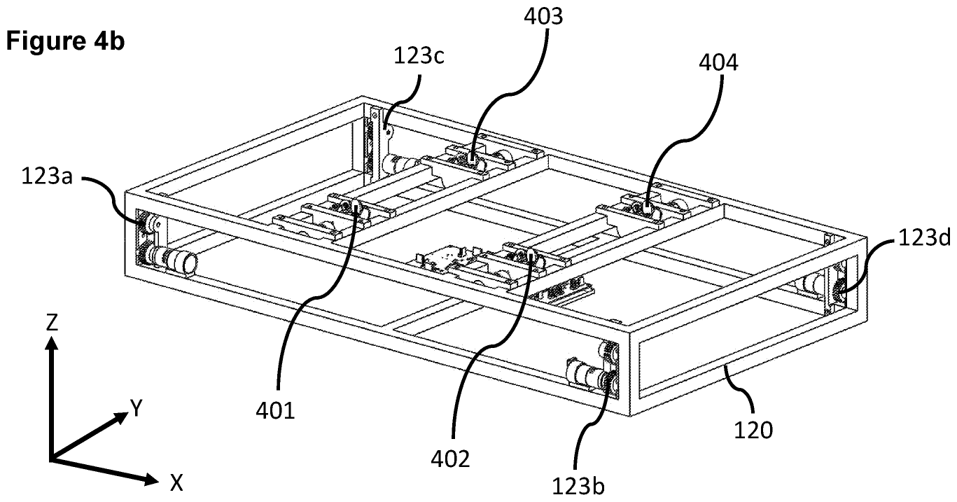

FIGS. 4a and 4b shows a first modification to the transporting device of the first embodiment. FIG. 4a shows a transporting device 100 of this first modification whilst FIG. 4b shows just the tray 120. In FIG. 4a, the Z-direction tracks 111a-111d are not positioned at the corners of transporting device. Instead, they are offset from the corners of the transporting device 100.

Unlike the tray 120 previously described, the X-direction movement unit and/or the Y-direction movement unit here comprises omniwheels 401-404, instead of a conveyor belt. In this regard, omniwheels are consisted to be wheels with small discs (called rollers) around the circumference which are perpendicular to the turning direction of the wheel. The effect is that the wheel can be driven with full force, but will also slide laterally with great ease.

To simplify FIG. 4b, only the X-direction movement unit is shown by way of four omniwheels 401-404. It is envisaged that an identical configuration, rotated 90 degrees about the Z-axis, would from the Y-direction movement unit. Causing the omniwheels 401-404 to rotate in a particular direction will cause a container 200 to move in a direction tangential to that rotation.

However, unlike regular wheels, omniwheels also permit movement in a direction at right angles by way of the rollers on the periphery thereof.

To this end, it will be appreciated that the mechanisms used by each of the X-direction movement unit, Y-direction movement unit and Z-direction movement units may be realised using any manner of available technologies. As explained, conveyor belts may be replaced by omniwheels, and any other reasonable mechanism may be suitably used.

The tray 120 of FIG. 4b shows detail of the Z-direction movement unit comprising pinions 123a-123d. In this example, the Z-direction movement unit is slightly offset from the corner of the tray 120 to match the position of the Z-direction track on the frame 110. In FIG. 4b the Z-direction movement unit comprises a total of eight pinions, with two pinions positioned near each corner of the tray 120. The two pinions are shown driven by a motor shown positioned next to the pinions 123a-123d.

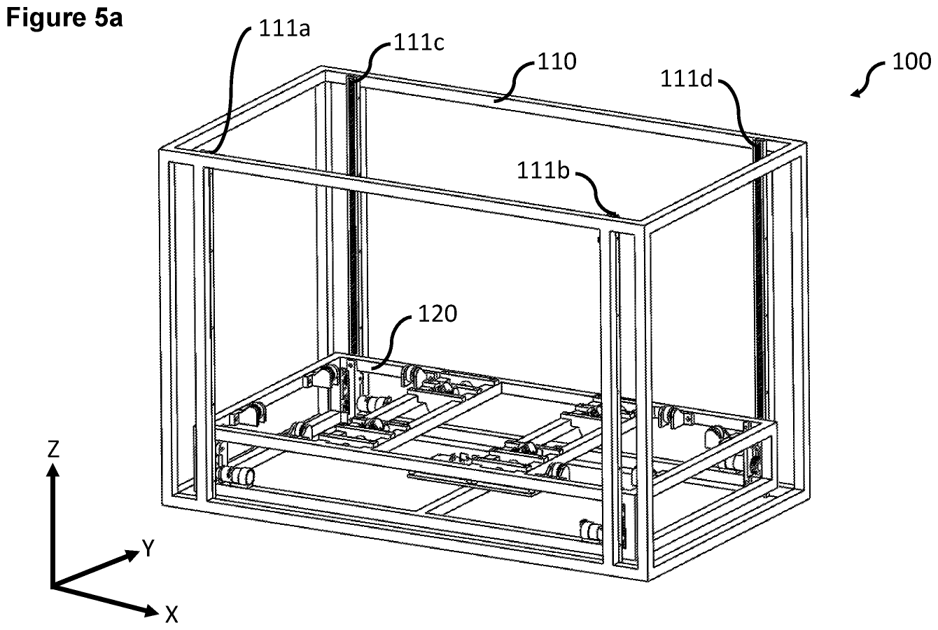

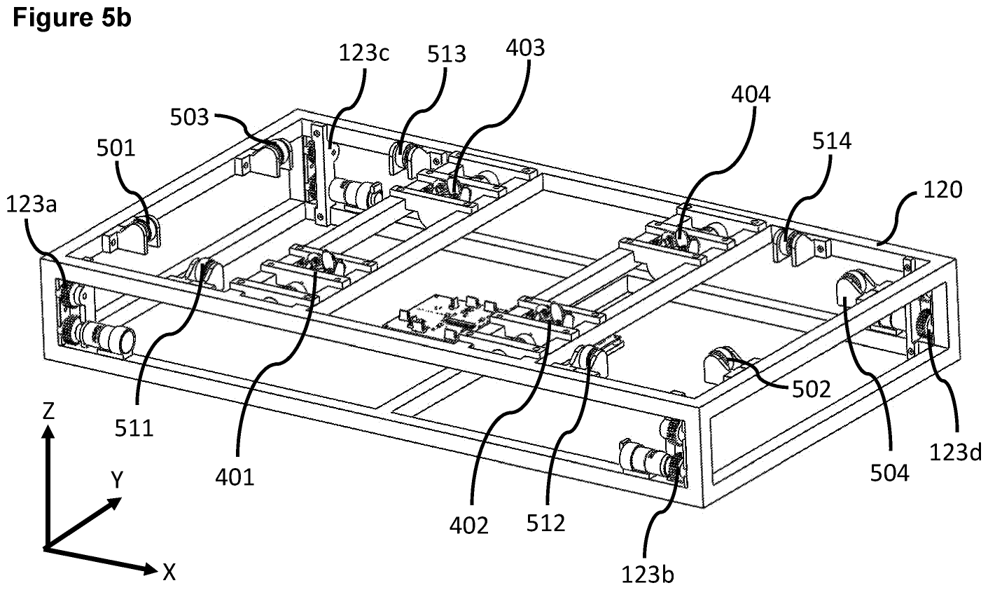

FIGS. 5a and 5b show a second modifications which may be added to the tray 120. FIG. 5a shows a transporting device 100 of this second modification whilst FIG. 5b shows just the tray 120.

As in FIG. 4a, a transporting device is shown with Z-direction tracks 111a-111d offset from the corners of the frame 110. The tray 120 is shown in more detail in FIG. 5b.

In particular, the tray 120 shown in FIG. 5b is similar to that of FIG. 4b in that it uses omniwheels to move containers 200 instead of conveyor belts. As in FIG. 4b, only the omniwheels used in X-direction movement unit are shown for simplicity. It is envisaged that an identical arrangement, arranged at 90 degrees as rotated about the Z-axis, would form the Y-direction movement unit. FIG. 5b also shows the pinions 123a-123d position near the corners of the tray 120 to correspond with the Z-direction tracks 111a-111d positioned near the corners of the frame 110.

FIG. 5b shows the addition of passive roller bearings to help support the container 200 and to help keep it straight when moving into/out of the tray 120. This is particularly important as the container 200 leaves/enters the tray 120 because it may not be supported by all of the omniwheels until fully located on the tray 120 and therefore more likely to move in an undesirable direction.

In particular, X-direction passive roller bearings 501-504 are shown for supporting a container 200 as it moves on and off the tray 120 in an X-direction. Similarly, Y-direction passive roller bearings 511-514 are shown for supporting a container 200 as it moves on and off the tray 120 in a Y-direction.

### Second Embodiment

The following describes a second embodiment of the present invention. The second embodiment, similar to the first embodiment, is concerned with a transporting device. However, the transporting devices of the second embodiment differ somewhat in their operation with respect to the first embodiment.

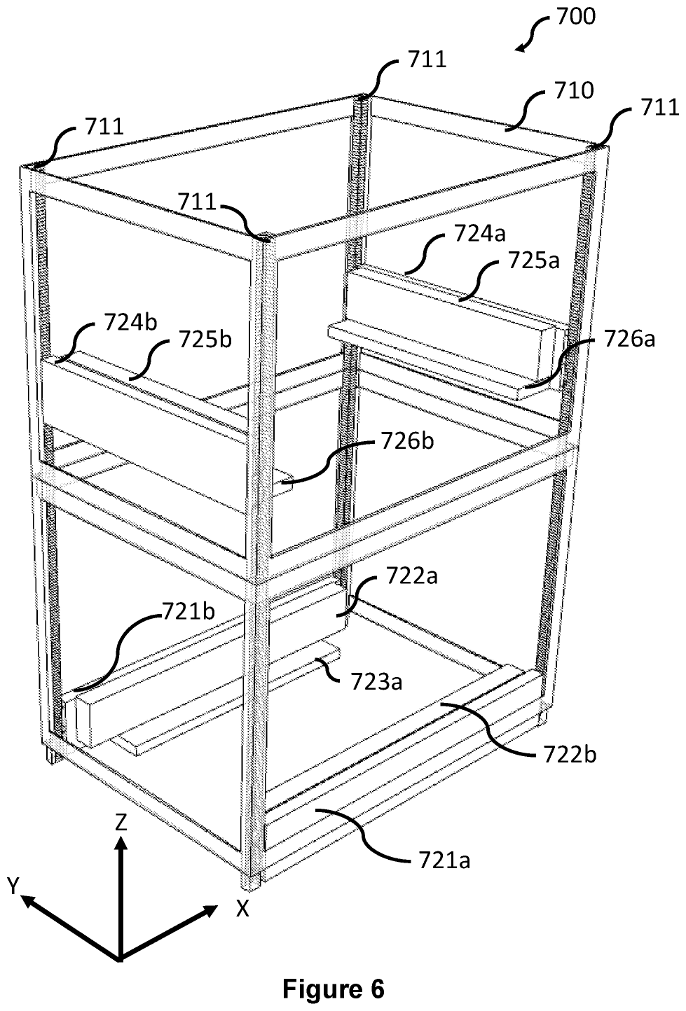

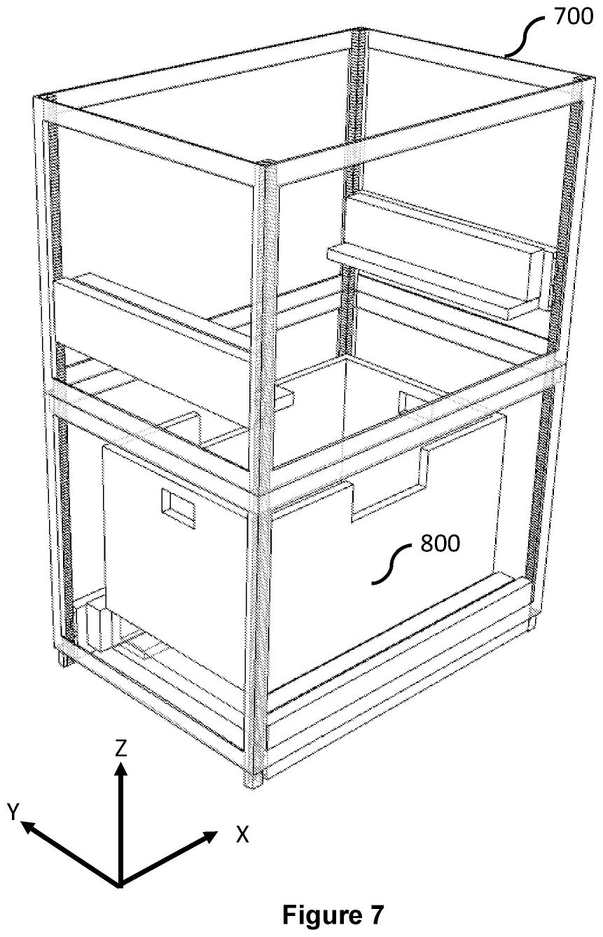

FIG. 6 shows a transporting device 700 according to the second embodiment of the present invention. FIG. 7 shows the transporting device 700 together with a container 800, the container 800 is one to be moved by the transporting device 700.

To achieve the movement, the transporting device 700 comprises a frame 710, a first movement unit and a second movement unit. The first movement unit is for supporting the container 800 and permits the movement of the container in an X and/or Z direction. The second movement unit is for supporting the container 800 and permits the movement of the container in a Y and/or Z direction.

To achieve transfer of the container 800 in each of X, Y and Z directions the frame 710 may comprise apertures through which the container 800 may pass into adjacent transporting devices or other facilities e.g. conveyor belts, pick stations, trucks or other storage or conveyance facilities. Apertures may be provided in the top and bottom of the frame 710 to allow the first/second movement units, with or without the container 800, to pass into the transporting device above or below.

To achieve this, the first movement unit comprises mechanisms to permit movement of the container 800 in X and/or Z directions. The second movement unit comprises mechanisms to permit movement of the container 800 in Y and/or Z directions. Each of the first movement unit and second movement unit may be wired to the frame 710 for power and communications and hence the extent of its travel may be restricted, in other words, the first movement unit and second movement unit may be able to travel a small distance into the frame 710 above and below (if present), but essentially remains within the frame 710.

To this end, in one non-limiting example, the first movement unit comprises a Z-direction movement unit and an X-direction movement unit. Optionally, the first movement unit further comprises a container support. In more detail, the Z-direction movement unit comprises two arms, a first arm 721a and a second arm 721b. Each of the first arm 721a and second arm 721b comprise mechanisms to permit Z-direction movement of the first movement unit.

Similarly, the second movement unit comprises a Z-direction movement unit and a Y-direction movement unit. Optionally, the second movement unit further comprises a container support. In more detail, the Z-direction movement unit comprises two arms, a first arm 724a and a second arm 724b. Each of the first arm 724a and second arm 724b comprise mechanisms to permit Z-direction movement of the second movement unit.

Each of the Z-direction movement units in each of the first movement unit and the second movement unit is arranged to move in the Z-direction. To achieve Z-direction movement of the container 800, the movement unit carrying the container 800 moves in the Z-direction. In this way, the vertical position of the first movement unit and second movement unit can be changed with respect to the frame 710. In more detail, in one non-limiting example, Z-direction movement of the container 800 is effected by way of interaction between a Z-direction track 711 positioned on the frame 710 and a pinion arranged on each of the Z-direction movement units. By rotating the pinion on each of the Z-direction movement units, the vertical position of the first movement unit and the second movement unit with respect to the frame 710 is adjusted by climbing up or down the Z-direction track 711 on the frame 710.

In the non-limiting example given in FIG. 6, four Z-direction tracks 711 are positioned at each corner of the frame 710, in particular, the four Z-direction tracks 711 comprise a first Z-direction track, a second Z-direction track, a third Z-direction track and a fourth Z-direction track. In this example, the Z direction tracks 711 are provided as gear racks arranged to interact with a pinion mounted on each Z-direction movement unit. The Z-direction movement unit of the first movement unit comprises four pinions arranged at each corner and each arranged to interact with a respective Z-direction track 711. For example, a first pinion is arranged to interact with the first Z-direction track, a second pinion is arranged to interact with the second Z-direction track, a third pinion is arranged to interact with the third Z-direction track and a fourth pinion is arranged to interact with the fourth Z-direction track.

Similarly, the Z-direction movement unit of the second movement unit comprises four pinions arranged at each corner and each arranged to interact with a respective Z-direction track 711.

In this way, the first movement unit and the second movement unit can operate independently and can pass each other in the Z-direction by operating on separate Z-direction tracks 711 which are arranged around a corner of the frame 710 i.e. two tracks at right angles to each other arranged at corners of the frame 710.

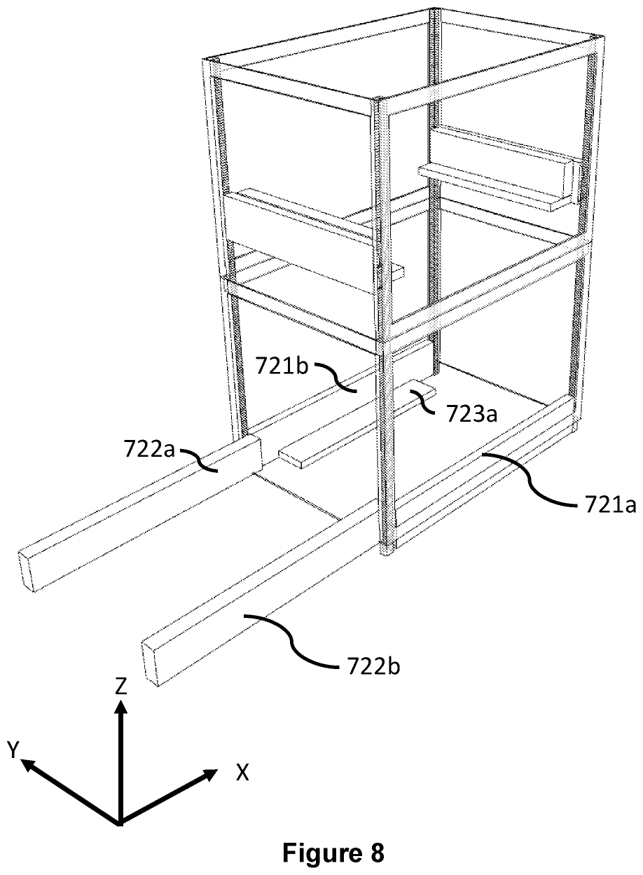

With regard to the X-direction movement unit of the first movement unit, movement of a container 800 in an X-direction is effected by way of extendable arms. Further detail of this is provided in FIG. 8. As shown in FIG. 8, the X-direction movement unit comprises a first arm 722a and a second arm 722b arranged to extend from the transporting device 700. This may be achieved by way of interaction with the Z-direction movement unit of the first movement unit. The extendable arms of the first movement unit are arranged to grip a container 800 in an adjacent location and arranged to retract so as to bring the container into the frame 710 of the transporting device 700. When within the transporting device 800, the first movement unit may relocate the container 800 in X-direction or Z-direction by way of the first movement unit. Alternatively, the container 800 may be handed over to the second movement unit to permit relocation in the Y-direction.

Optionally, the first movement unit may further comprise container supports 723a. Each of the Z-direction movement units may comprise a container support on each of the arms thereof. The container supports are for supporting a container when moving within the frame 710. However, to ensure that collisions between container supports 723a and the second movement unit are avoided, the container supports 723a may need to be hinged and to move themselves to be co-planar with the Z-direction movement unit as necessary. In this way, the first movement unit can move from a position below the second movement unit, to a position above the second movement unit, while effecting movement of the container 800.

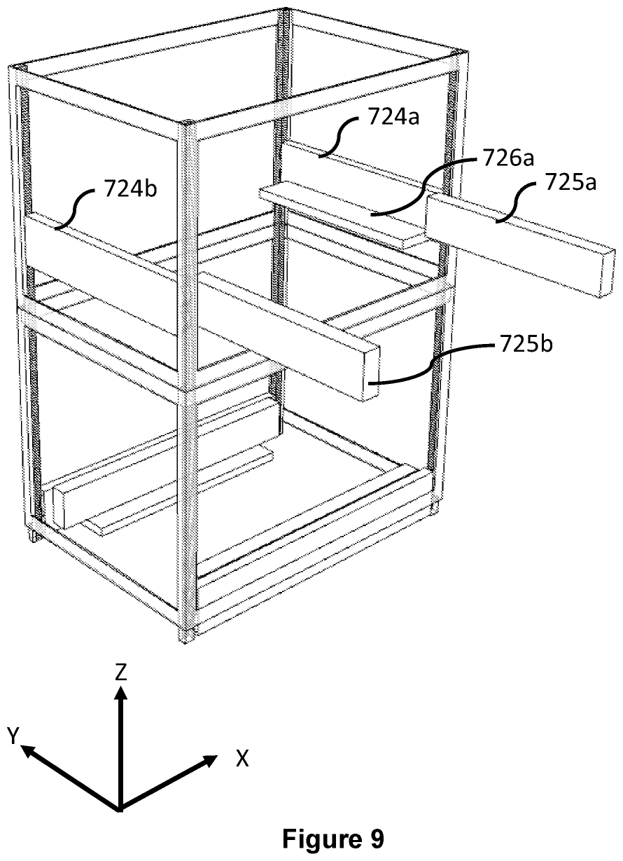

With regard to the Y-direction movement unit of the second movement unit, movement of a container 800 in a Y-direction is effected by way of extendable arms. Further detail of this is provided in FIG. 9. As shown in FIG. 9, the Y-direction movement unit comprises a first arm 725a and a second arm 725b arranged to extend from the transporting device 700. This may be achieved by way of interaction with the Z-direction movement unit of the second movement unit. The extendable arms of the second movement unit are arranged to grip a container 800 in an adjacent location and arranged to retract so as to bring the container 800 into the frame 710 of the transporting device 700. When within the transporting device 800, the second movement unit may relocate the container 800 in a Y-direction or Z-direction by way of the second movement unit. Alternatively, the container 800 may be handed over to the first movement unit to permit relocation in the X-direction.

Optionally, the second movement unit may further comprise container supports 726a. Each of the Z-direction movement units may comprise container supports on each of the arms thereof. The containers support are for supporting a container when moving within the frame 710. However, to ensure that collisions between container supports 726a and the first movement unit are avoided, the container supports 726a may need to be hinged and to move themselves to be co-planar with the Z-direction movement unit as necessary.

In this way, the transporting device 100 of the second embodiment is arranged to permit the transfer of containers 120 between adjacent transporting devices 100 in all 3 dimensions.

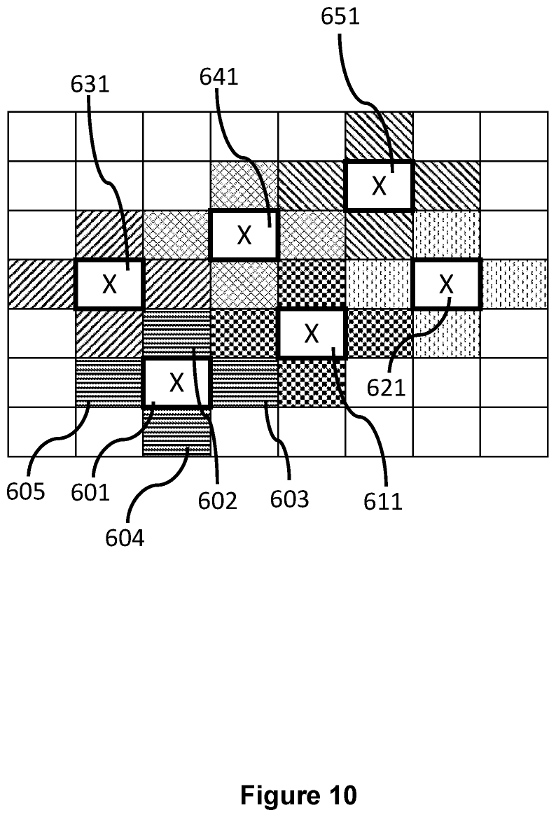

A particular advantage of the transporting device 700 of the second embodiment is shown in FIG. 10. FIG. 10 shows a storage system according to the second embodiment of the present invention. In particular, each cell shown represents shelves on which may be positioned a container 800. Selective cells are not shelves but rather transporting devices 700 as identified as ‘X’. In particular, locations 601, 611, 621, 631, 641, 651 are locations at which transporting devices 700 are installed. It is envisaged that each location comprises more than one transporting device 700 to thereby create a stack of transporting devices 700 to any suitable height, in this way containers of any determined depth can be formed to provide efficient storage of containers. Around each transporting device 700 is an area of operation in which the transporting device 700 is able to reach containers 800. For example, locations 602, 603, 604 and 605 are ones able to be reached by the transporting device 700 located at 601. In this position, the first movement unit and second movement unit can reach containers positioned in locations 602-605 as necessary and relocate them in any of X, Y and Z directions to thereby move them around the storage system. Similar areas are marked for equivalent transporting devices 700 in other locations of the storage system by way of patterns on cells indicating their availability to nearby transporting devices. For example, the four cells with a checkerboard pattern around location 611 are locations which are accessible to the transporting device 700 located at location 611.

Although the second embodiment has been described with extendable arms which reach into a directly neighbouring storage location for containers, this need not be the case. In particular, the length of arm of the extendable arm is not limited to a single container space but rather may reach further, for example, two, three or four container spaces. In this example, the extendable arms may be able to reach from the transporting device 700 to reach a container 800 which is two container spaces in the storage system. As will be appreciated, this will require the container spaces between the transporting device 700 and the container 800 to be retrieved to be free of obstacles, such as other containers.

Therefore, a particular advantage of the second embodiment is that it doesn't require a storage system filled with transporting devices 700, instead only select locations (one fifth of locations) requires a transporting device 700 and still permit full accessibility to all containers 800 within the storage system. As referred to previously, by stacking, vertically, multiple transporting devices 700 in particular locations permits the creation of a storage system of any suitable X, Y or Z dimension to fit the application.

### MODIFICATIONS AND VARIATIONS

Many modifications and variations can be made to the embodiments described above, without departing from the scope of the present invention.

With regard to the first embodiment, the tray 120, when operating in a cluster as described with regard to FIG. 3 may have to travel from a lower transporting device 100c to an upper transporting device 100c′ to thereby effect an X-direction or Y-direction movement of the container 200c to nearby transporting devices. However, such alignment of the lower transporting device 100c with the upper transporting device 100c′ may be difficult to achieve in practice. In particular, the Z-direction tracks of each of the lower 100c and upper 100c′ transporting devices would require careful alignment to ensure that the tray 120 transitions smoothly between the transporting devices without fouling up the pinions of the tray 120 on the Z-direction tracks. Accordingly, installation and servicing of such transporting devices may become difficult. Therefore, it is envisaged that the tray 120 may further comprise an extension unit arranged to raise from the body of the tray 120 a predetermined distance such that a tray body may remain captive in the lower transporting device 100c whilst the extension raises the container 200c up into the upper transporting device 100c′. The extension unit of the tray 120 comprises the X-direction movement unit and the Y-direction movement unit to thereby, when fully extended, move the container 200c into the neighbouring transporting devices as required. In this way, the tray 120 can remain captive in the lower transporting device 100c whilst still effecting the Z-direction movement of the container 200c and allowing its movement into neighbouring transporting devices. It is envisaged that the extension unit may be form in one of a manner of ways, such as rack and pinions, scissor lifts, hydraulic lifts, linear motor system or any other suitable vertical lifting mechanism. The extending unit may be driven by the same motor which drives the Z-direction motion of the tray 120, in this way few motors are required within the tray 120. It will be appreciated that such a mechanism can also be used in reverse so as to lower a container 200c onto the body of the tray 120 from a neighbouring transporting device. Such a mechanism may be automatically activated by the presence of the tray 120 at the top of the lower transporting device 100c, such as my mechanical activation, electrical activation or the like.

With regard to the second embodiment of the present invention, the transporting device 700 provided therein performs all of the functions of container movements in each of the X, Y and Z directions. However, it is envisaged that such a transporting device 700 may be modified to perform only a selection of those functions described to increase modularity. More specifically, the transporting device may comprise only the first movement unit and omit the second movement unit. In this way, the modified transporting device 700 would only perform the functions of moving a container 800 in an X-direction and/or a Z-direction but not a Y-direction. Similarly, a modified transporting device may comprise only the second movement unit and omit the first movement unit. In this way, the modified transporting device 700 would only perform the functions of moving a container 800 in a Y-direction and/or a Z-direction but not an X-direction. In this way, modularity of the transporting device is achieved which may be more suitable in particular applications.

With regard to each of the first and second embodiments, the storage system provides a space efficient, power efficient, easily installed, easily reconfigured system, which further permits the use of existing containers which may already be optimised for other parts of a particular process. It can also operate when sparsely populated. To this end, a user could buy (or rent) as many transporting devices as needed, add more, and return surplus. They may be installed, operated and removed at an installation in the space of a single day. Advantageously multiple containers can move concurrently providing parallelism. Moreover, the storage system can scale with demand simply by using more transporting devices. A modular system of interlocking transporting devices enables a rapid and simplified deployment. In this regard, the containers may be of different types e.g. different dimensions, materials etc. The transporting devices described previously may operate equally as well even with different non-standard containers. Alternatively/In addition, the containers may be used for different purposes. For example, a first type of container may be provided to store products to be kept at an ambient temperature whilst a second type of container may be provided to store products in a frozen state. Similarly, other types of containers specific to the products they store are envisaged including containers to store containers. All of these containers may be used in one system comprising a cluster of individual transporting devices.

In a modification of the system, sections of a cluster and/or individual transporting devices may be motorised. In particular, the design of the frame 110 is such spare height is reserved which may be used for a drive mechanism underneath the frames. In other words, when a plurality of transporting devices are arranged in a cluster then between the floor of the installation and the lowest point of the tray in a bottom layer of transporting devices provides a space which may be useful such that a number of transporting devices could be motorised to move themselves to a conveyor spur for populating with containers and then move itself onto a van or trailer when completed.

In another modification the trays may be configured to be somewhat flatter—without the X-direction movement unit or the Y-direction movement unit. Instead, self-driving containers 200 or trays 120 could be used. For example, containers of this type could be placed on the floor, and they drive themselves over to the appropriate loading bays and onto the vans—then the combination of the horizontal drives on the container 200 and the vertical capability of the transporting devices 100 in the vans sorts the totes as required.

In another modification, the transporting devices are envisaged to comprise fewer than all of the X, Y and Z direction movement units. In this way, a particular transporting device may only be capable of moving a container in, for example, the X and Y directions but not the Z-direction. Instead, a different transporting device differently configured (for example, with just X and Z direction movement capabilities) is located elsewhere in the cluster for moving the container in the Z-direction. More generally, the transporting device only has two of the three potential movement units. In this way, the transporting device is only able to move a container in the two directions rather than all three. Similarly, transporting devices may only have one of the three potential movement units so that it can only move containers in an X-direction, a Y-direction or a Z-direction. It is envisaged that other transporting devices located elsewhere in the cluster would provide the missing directional capabilities to move containers in other directions. These modifications are advantageous with regard to simplifying the mechanical design and operation of the transporting device but which still permits full three direction functionality in the cluster as a whole.

The containers are shown comprising a housing that, in this example, comprises a base and four side walls, defining an open cavity, a top surface of the housing being closable by a top surface or lid. In this example, the side walls surround a periphery of the base and are either fixed to the base or integrally formed therewith. However, it is envisaged that other forms and designs of container may be used. Moreover, a container may further comprise a lid to contain the items.

With regard to each of the first and second embodiments, the transporting devices explained above may be integrated with other devices to complement container movements in each of the X, Y and Z directions. In particular, the transporting devices may be located near, for example, conveyor belts to provide particularly fast X and/or Y direction movements at speeds which may not be possible using transporting devices alone. With regard to Z direction movements, lift means may be provided, such as paternoster lifts, to provide fast Z-direction movements. In this way, particular fast routes in and around a storage system may be constructed to complement the storage system of transporting devices.

In the first and second embodiments, the transporting devices of each embodiment are described forming storage systems comprising a plurality of transporting devices, respectively. To achieve this construction it may be necessary to connect together the plurality of transporting devices. In some instances, it may be required to accurately connect the transporting devices so that particular features of one transporting device match up with particular features of a neighbouring transporting device. To this end, a number of different manners is envisaged to connect transporting devices together. For example, the connecting means/fastening means may comprise bolts, clips and/or magnets or the like.

The transporting devices described previously may have a number of different uses and be used in many different situations. For example, the transporting devices and clusters thereof may advantageously be used in low-gravity/zero-gravity environments. Therefore, reference herein to X, Y and Z directions and planes are exemplary only and other reference frames can be employed, depending upon the environment and/or orientation of the cluster, for example in a zero-gravity environment, for example orbiting a planet, the z-direction can differ from the z-direction on a surface of a planet. Transporting devices may also be used in vans/ships/fridges/attics/cupboards/corner shops for storing items in a reconfigurable configuration. In one example, transporting devices may be loaded into a van. Whilst the van is moving to a delivery location the transporting devices may reconfigure the positions of containers to provide those containers required for the next delivery are located conveniently for example, at the front of the cluster. Alternatively, it could be used for car parking, fulfilment centres (storage & retrieval, container buffering etc.), shopping aisles, in a van, in a kitchen cupboard or the like. Similarly, the transporting devices may used to load and unload a van on containers. Additionally or alternatively, transporting devices may be located on the van and used to load and unload a van onto a corresponding cluster of transporting devices located at the loading dock.

Transporting devices may be used with delivery robots (such as bipedal robots) to load and unload with containers to/from the cluster of transporting devices. Similarly, the delivery robots may comprise a transporting device arranged to engage with a cluster of transporting devices to receive/deliver containers therefore/thereto.

It is also envisaged that products stored within containers within transporting devices may be manipulated by robotic arms and the like. In this way, products may be moved from one container to another container without the container leaving the location of a transporting device. Moreover, a transporting device may further comprise a robotic arm for picking products from a container stored therein and relocating the product to another container or to another container within a different transporting device.

It is also envisaged that transporting devices may be used in combination with other material handling equipment such as those systems disclosed in Ocado's WO2015019055 A1 (which is incorporated herein by reference) and/or in Ocado's WO2019068775A1 (which is incorporated herein by reference). Transporting devices may also be used in conjunction with Autonomous Guided Vehicles (AGVs). In this regard, transporting devices may deliver or receive containers from an AGV. Similarly, the AGV may further comprise a transporting device and arranged to receive/deliver a container from/to a separate cluster of transporting devices.

Each container may be arranged to hold many different goods. Each container can contain different goods within a single row or column of transporting devices. Furthermore, transporting devices can be empty whilst stored in the cluster or can contain items such as parcels or other items for future delivery.

As will be appreciated, the transporting devices are configured to move containers around the cluster and to perform operations. Operations, in this example, include moving a container from one location within the cluster to another. The transporting devices may be assigned to communicate with the one or more base stations (not shown). The transporting devices are not necessarily all of the same type of transporting device. In this respect, the cluster can comprise different robotic devices, for example transporting devices, with various shapes, designs and purposes, for example, transporting devices can vary in dimensions and volumes occupied.

In this example, the transporting devices have, respectively, radios, digital signal processors, processors, real time controllers, batteries and motors, magnets, sensors, and/or connectors. Some of these can be optional.

Although the container described previously have been illustrated as formed of bases with walls arranged around the base, it is envisaged that the container may be formed as a container and/or a pallet. Therefore, the transporting device is not limited to a four-walled container but is envisaged to take other forms such as a base only without walls and/or a base with walls which number fewer or greater than four.

With regard to both of the first embodiment and the second embodiment, the above implementations lend themselves well to a warehouse comprising the cluster. In this regard, the cluster may be employed in a warehouse and/or a cluster or a plurality of clusters may constitute warehouses and/or form part of a larger warehouse in an online retail system. However, the above system finds applications in other environments, for example within a vehicle or in an aeronautical context, for example in space.

In this respect, the system and apparatus described herein can be scaled to any desired size, for example the cluster could form part of a domestic piece of equipment, such as a refrigerator where an item stored in the refrigerator is selected through a user interface associated with the refrigerator and the item, for example butter, is stored in a container in a transporting device in a cluster in the refrigerator and the transporting device carrying the desired item instructed to be translated to a port for provision to an operator, thereby removing the need to open a door of the refrigerator too often. Alternatively, the cluster could be much larger and disposed within a so-called Materials Handling Equipment (MHE) storage and picking system forming part of an online retail operation.

In such an example, the transporting devices of the cluster of the MHE can contain items being stored such as groceries for example, or could contain customer orders awaiting shipment (which may be held in further containers known as delivery containers held within the transporting devices) or could contain empty delivery containers comprising bags awaiting customer orders being placed therein.

In a further example, there could be two systems associated with each other, a chilled system for storing goods requiring storage in chilled conditions and an ambient system for storing groceries not requiring chilling, such as cereals, tissues, sparkling water, etc. Indeed, a frozen system can be provided for holding frozen goods, such as ice cream, therein.

In other examples, the transporting devices or containers could individually comprise chilling means so that the whole cluster or a region of the cluster need not be chilled. This also allows different transporting devices to be employed to contain goods requiring specific storage temperatures. Indeed, the transporting devices can additionally or alternatively support living organisms, for example plant life and so can be arranged to contain a growing membrane and/or a water reservoir.

Additionally or alternatively, the cluster can be employed to store parcels and/or other packages and can support sequencing of the transporting devices and shipping.

As intimated above, the transporting devices or containers can comprise other services, for example their own power supplies to support for example lighting systems, computing means, heating means, chilling means and/or communication means. The transporting devices can be capable of device-to-device communication via any appropriate means.

Although in some embodiments described above, walls of an environment in which the cluster is disposed are provided, the skilled person should appreciate that in some embodiments, such supporting walls are not required.

In the above example, it is sometimes desirable to move a container to a port where the container is further “processed”, for example for picking an item from the container or onward transportation of the container, for example using a conveyor or other mechanism.

It will be appreciated that whilst the system described above is in the context of transporting devices being used to cause a container to traverse a cluster, the above technique can be applied to any number of systems where a number of moveable items need to be moved across a volume, for example but not exclusively, a three-dimensional structure without interference in as simple yet quick manner as possible. It should also be appreciated that although the above examples have been described in the context of relocation of one or more containers within the cluster, the term “within” is intended to embrace relocation of one or more containers at a peripheral surface of the cluster.

The transporting devices and clusters described previously may be used as a part of a grocery order fulfilment system. In this connection, the cluster may be utilised with at least one peripheral arranged to perform a function in combination with the cluster.

For example, the fulfilment system may further comprise a decant station arranged to provide a location at which manual/automated removal of packaging of inbound products may be effected with the inbound products are placed in containers.

The container may then be stored in the cluster of transporting devices until a time at which they are requested to be used in the fulfilment of an order. To achieve this, the cluster may be used with a picking station at which containers storing products are transported by transporting devices, the containers arranged to store a customer's order. In one example, a removable container may be nested inside the container transported by the transporting device. At a picking station, manual/automated means may be used to move at least one product from a storage container into a nested container for storing a customer's order. In one example, the at least one product may be moved into the nested container. After the process of picking has been completed, the storage container may be re-stored in the cluster along with the nested container arranged to store a customer's order.

As mentioned, in one example, a nested (removable) container may be located inside the container for use in receiving products of a customer's order. A load station may be located adjacent to the cluster at which storage containers, moved by transporting devices, are loaded with an empty nested (removable) container and then loaded into the cluster.

The cluster may also be used with an unloading station at which containers are located when they have been filled with a particular customer's order (a customer order may comprise one or more different products or varying quantities). At a loading station, the container may be loaded onto a frame suitable for loading onto a van. Alternatively, the transporting device may be loaded directly onto a van for delivery to a customer. Alternatively, a nested container located inside the storage container may be removed for loading onto a van whilst the storage container returns to the cluster. Additionally or alternatively, once the container located inside the storage container has been removed, the storage container may be directed to the load station to receive an empty nested (removable) container for receiving a customer's order or the transporting device may be directed to the decant station to receive inbound products to be stored in the cluster.

Containers may also be cleaned once returned from a customer location. At a cleaning station, the container may be emptied of any dirt/leftovers and, optionally, cleaned with a solvent e.g. water. After emptying/cleaning the container may be reintroduced into the cluster for use with another order/storage of products. Additionally or alternatively, once the container has been emptied/cleaned, the container may be directed to the load station to receive an empty nested (removable) container for receiving a customer's order or the container may be directed to the decant station to receive inbound products to be stored in the cluster. It will be appreciated that references to a van are envisaged to include references to other means of transportation such as trailer trucks, drones, trains etc.

The foregoing description of embodiments of the invention has been presented for the purpose of illustration and description. It is not intended to be exhaustive or to limit the invention to the precise form disclosed. Modifications and variations can be made without departing from the spirit and scope of the present invention.

1-13. (canceled)

14. A transporting device for moving a container, the transporting device comprising:
a frame including a vertical Z-direction track; and
a tray for supporting a container, the tray including:
an X-direction movement unit configured to move the container in an X-direction;
a Y-direction movement unit configured to move the container in a Y-direction; and
a Z-direction movement unit configured to move the tray in a Z-direction by way of interaction with the Z-direction track.

15. The transporting device according to claim 14, wherein the Z-direction track comprises:
a gear rack; and
the Z-direction movement unit includes a pinion.

16. The transporting device according to claim 14, wherein the Z-direction track comprises:
four gear racks, each positioned at separate corners of the frame, and wherein the Z-direction movement unit includes four pinions, each positioned at separate corners of the tray.

17. The transporting device according to claim 14, wherein the X-direction movement unit comprises:
a conveyor belt; and/or
wherein the Y-direction movement unit includes a conveyor belt.

18. The transporting device according to claim 14, wherein the X-direction movement unit comprises:
an omniwheel; and/or
wherein the Y-direction movement unit includes an omniwheel.

19. The transporting device according to claim 14, wherein the tray comprises:
an extension unit configured for raising and/or lowering a container from a body of the tray.

20. A transporting device for moving a container, the transporting device comprising:
a frame including a Z-direction track;
a first movement unit configured to move the container in an X-direction and/or a vertical Z-direction, wherein movement in the Z-direction is achieved by way of interaction with the Z-direction track; and
a second movement unit configured to move the container in a Y-direction and/or a Z-direction, wherein movement in the Z-direction is achieved by way of interaction with the Z-direction track.

21. The transporting device according to claim 20, wherein the Z-direction track comprises:
a gear rack; and
the first movement unit is configured to achieve Z-direction movement unit by a pinion; and
the second movement unit is configured to achieve Z-direction movement unit by a pinion.

22. The transporting device according to claim 20, wherein the Z-direction track comprises:
four gear racks, each positioned at separate corners of the frame; and
the first movement unit is configured to achieve Z-direction movement unit using four pinions each positioned at separate corners of the first movement unit; and
the second movement unit is configured to achieve Z-direction movement unit using four pinions each positioned at separate corners of the second movement unit.

23. The transporting device according to claim 20, wherein the first movement unit comprises:
extendable arms configured to achieve X-direction movement; and
wherein the second movement unit includes extendable arms configured to achieve Y-direction movement.

24. The transporting device according to claim 20, wherein each of the first movement unit and second movement unit comprise:
container supports.

25. A storage system in combination with a transporting device according to claim 20, the storage system comprising:
a plurality of the transporting devices;
wherein the plurality of transporting devices are arranged in a cluster configured to transfer containers in X, Y and Z-directions.

26. The storage system according to claim 25, comprises:
a picking station configured and arranged to receive a container transported by a transporting device of the plurality of transporting devices, and including:
means for moving at least one item into the container for transport to another location in the cluster.

27. The transporting device according to claim 15, wherein the X-direction movement unit comprises:
a conveyor belt; and/or
wherein the Y-direction movement unit includes a conveyor belt.

28. The transporting device according to claim 15, wherein the X-direction movement unit comprises:
an omniwheel; and/or
wherein the Y-direction movement unit includes an omniwheel.

29. The transporting device according to claim 28, wherein the tray comprises:
an extension unit configured for raising and/or lowering a container from a body of the tray.

30. The transporting device according to claim 29, wherein the Z-direction track comprises:
a gear rack; and
the first movement unit is configured to achieve Z-direction movement unit by a pinion; and
the second movement unit is configured to achieve Z-direction movement unit by a pinion.

31. The transporting device according to claim 30, wherein the first movement unit comprises:
extendable arms configured to achieve X-direction movement; and
wherein the second movement unit includes extendable arms configured to achieve Y-direction movement.

32. A storage system in combination with a transporting device according to claim 31, the storage system comprising:
a plurality of the transporting devices;
wherein the plurality of transporting devices are arranged in a cluster configured to transfer containers in X, Y and Z-directions.

33. The storage system according to claim 32, comprising:
a picking station configured and arranged to receive a container transported by a transporting device of the plurality of transporting devices, and including:
means for move at least one item into the container for transport to another location in the cluster.
